(19) United States
(12) Patent Application Publication
(10) Pub. No.: US 2021/0368271 A1
(43) Pub. Date: Nov. 25, 2021

(54) ACOUSTIC TRANSDUCERS WITH POLE PLATES

(71) Applicant: HEWLETT-PACKARD DEVELOPMENT COMPANY, L.P., SPRING, TX (US)

(72) Inventors: OWEN P COLUMBUS, SPRING, TX (US); KEN MacLEAN, SPRING, TX (US); PHILIP WRIGHT, OTTAWA (CA)

(21) Appl. No.: 16/762,697

(22) PCT Filed: Feb. 26, 2018
(86) PCT No.: PCT/US2018/019708

§ 371 Date: May 8, 2020

(51) Int. Cl. H04R 9/02; H04R 9/06; H04R 9/04

(52) U.S. Cl. CPC H04R 9/025; H04R 9/045; H04R 9/06

(57) ABSTRACT

An example acoustic transducer device includes a magnet and a pole plate connected to the magnet. The pole plate includes a nickel-iron alloy having nickel as a principal component. The device further includes a diaphragm movable relative to the pole plate to generate a sound and a coil connected to the diaphragm. The coil is to extend into a gap at the pole plate. The coil is to magnetically interact with a magnetic field provided to the gap by the magnet and the pole plate to drive the diaphragm.

### BACKGROUND

Speakers convert electrical signals into sound. Various kinds of computer devices use speakers to communicate information or playback audio media, such as music, audiobooks, operating system messages, and similar.

### BRIEF DESCRIPTION OF THE DRAWINGS

FIG. 1 is a cross-sectional diagram of an example acoustic transducer device that includes an example nickel-iron alloy pole plate.

FIG. 2 is a perspective view of another example acoustic transducer device that includes an example nickel-iron alloy pole plate.

FIG. 3 is a cross-sectional view of the example acoustic transducer device of FIG. 2 at section plane A-A.

FIG. 4 is a schematic diagram of an example speaker device including an example acoustic transducer device that includes an example nickel-iron pole plate.

FIG. 5 is a cross-sectional diagram of an example acoustic transducer device that includes an example nickel-iron alloy pole plate and a short ring.

FIG. 6 is a graph of simulated magnetic flux density for an example acoustic transducer device that includes an example nickel-iron alloy pole plate.

### DETAILED DESCRIPTION

An acoustic transducer may be a speaker or micro-speaker useable in a notebook computer, smartphone, tablet computer, or other portable electronic device. Materials used for such a speaker may be to reduce power consumption and/or increase sound output. Further, operation of a diaphragm of the speaker may be more linear and have less distortion.

A pole plate of the speaker may be made from a high nickel alloy that has high magnetic permeability and high capacity for saturation. A back plate and a top plate may also be made from a high nickel alloy. Supermalloy and mu-metal are examples of such an alloy. Use of such a pole plate may allow a stronger magnet to be used in the speaker. For example, N52 grade neodymium may be used instead of N32. A high permeability and/or high saturation capacity of the pole plate may be able to direct greater magnetic flux to the driving coil, thereby allowing use of a stronger magnet.

In addition, beryllium or an alloy thereof may be used for the speaker coil and diaphragm to reduce mass that is to be oscillated. This may also reduce power consumption and/or increase sound output.

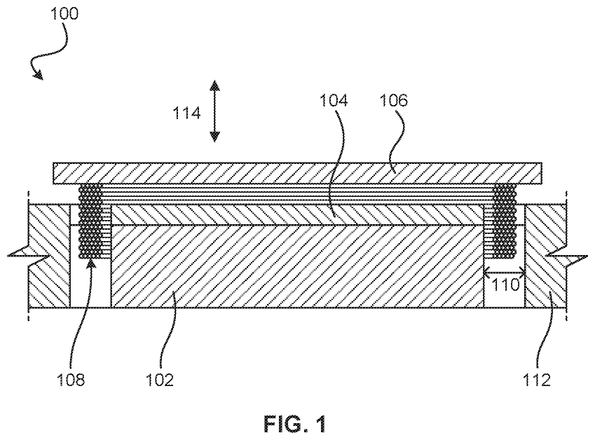

FIG. 1 shows an example acoustic transducer device 100. The acoustic transducer device 100 may be a speaker, microphone, or similar device. The acoustic transducer device 100 may be provided to a portable electronic device, including a wearable device.

The acoustic transducer device 100 includes a magnet 102, a pole plate 104, a diaphragm 106, and a coil 108.

The diaphragm 106 is movable relative to the pole plate 104 to generate a sound. The coil 108 is connected to the diaphragm 106 and extends into a gap 110 at the pole plate 104. The gap 110 may be with respect to another component 112 of the device 100, such as another magnet, plate, housing, frame, or similar. The coil 108 magnetically interacts with a magnetic field provided to the gap 110 by the magnet 102 and the pole plate 104 to drive the diaphragm 106 in an oscillating manner, as shown by arrow 114, to generate sound.

The diaphragm 106 may be disc-shaped, rectangular, or other shape, and may be generally flat. The diaphragm 106 may be movably suspended relative to the pole plate 104 by a suspension that may be connected to a housing or frame that secures the components of the device 100.

The pole plate 104 is connected to the magnet 102. For example, the pole plate may be held to the magnet by a housing or frame, by attraction to the magnet, by adhesive, or by similar technique. The pole plate 104 is to direct magnetic flux of the magnet 102 into the gap 110. The pole plate 104 may be generally planar and may have ends to direct magnetic flux into the gap 110. The pole plate 104 may focus magnetic flux of the magnet into the gap 110.

The pole plate 104 includes a nickel-iron alloy having nickel as a principal component. For example, the primary component of the alloy by weight may be nickel. The pole plate 104 may be made of a nickel-iron alloy having at least 70% nickel, such as supermalloy, which in one example composition is 75% nickel, 20% iron, and 5% molybdenum. Another example alloy is a mu-metal, which in one example composition is 77% nickel, 16% iron, 5% copper, and 2% chromium or molybdenum. Various other alloys that are mainly composed of nickel and that include other elements such as iron, copper, chromium, molybdenum, silicon, manganese, and similar may be used. The proportions of the other elements may be varied and iron need not be second.

The pole plate 104 may be made of a magnetically soft material having a high or extremely high magnetic permeability, such as between about 600,000 and about 1,200,000 newtons per ampere squared, between about 700,000 and about 1,000,000 newtons per ampere squared, approximately 800,000 newtons per ampere squared, or similar. The material may also have a low coercivity, such as less than about 100 amperes per meter, less than about 90 amperes per meter, approximately 80 amperes per meter, or similar.

The pole plate 104 composed of a material discussed above may allow use of a magnet 102 of increased strength. That is, the pole plate 104 may provide sufficient permeability and/or saturation capacity that allows use of a magnet 102 that provides greater flux. That is, the pole plate 104 may direct magnetic flux, which could otherwise be wasted or ineffective, into the gap 110.

The magnet 102 may be a neodymium magnet, such as is available under the grade designation N50 or N52 and such that may be composed of neodymium, iron, and boron. In other examples, other permanent rare-earth magnets may be used. The magnet 102 may have a residual flux density of at least 1.4 tesla. The magnet 102 have a maximum energy product of at least 370 kilojoules per cubic meter.

The coil 108 may include beryllium, which is electrically conductive and less dense than various other conductors. This may reduce the mass of the coil 108, which may thereby reduce mass of the oscillating components of the device 100 and reduce power required to drive the device 100. The coil 108 may be principally composed of beryllium. For example, the coil 108 may be composed substantially entirely of beryllium. In another example, the coil may be composed of beryllium-copper alloy. Copper may increase the electrical conductivity and may increase the mass of the coil 108.

The diaphragm 106 may include beryllium to reduce moving mass. The diaphragm 106 may be principally composed of beryllium, may be made substantially entirely of beryllium, or may be made of a beryllium alloy.

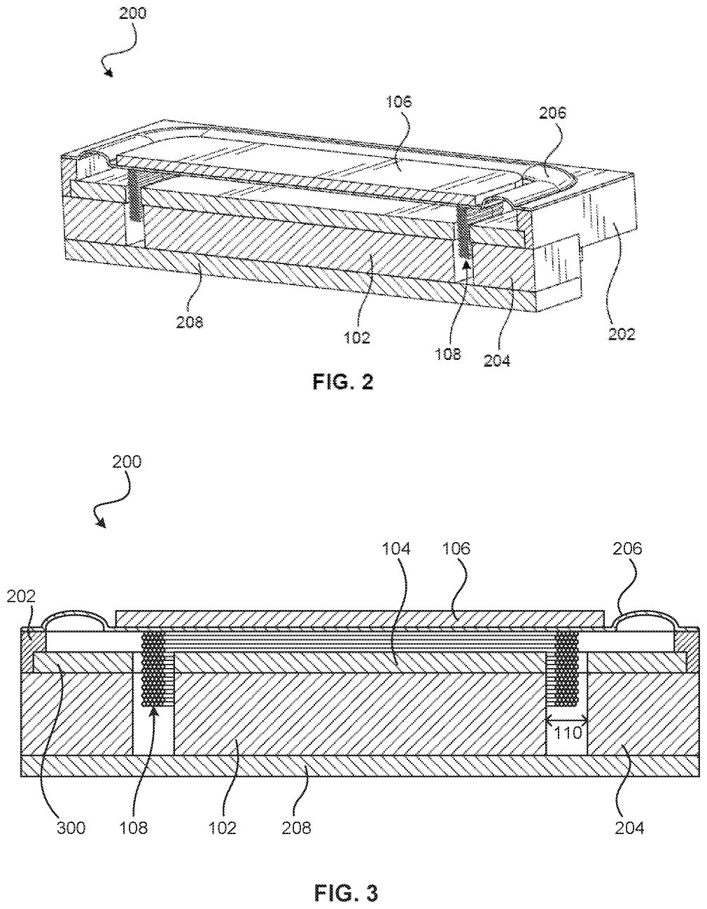

FIG. 2 shows another example acoustic transducer device 200. The acoustic transducer device 200 may be a speaker, microphone, or similar. The acoustic transducer device 200 may be similar to the other acoustic transducer devices discussed herein and related description may be referenced. Like reference numerals denote like components.

The acoustic transducer device 200 includes a frame 202, a magnet 204, a diaphragm 106, a suspension 206, and a back plate 208.

The frame 202 secures various components of the device 200. The frame 202 may be made of carbon steel, stainless steel, aluminum, magnesium, polymer, or other material. The frame 202 may be referred to as a housing and may be to keep dust and other contaminants out of the interior of the acoustic transducer device 200.

The suspension 206 connects the diaphragm 106 to the frame 202. The suspension 206 may include polymer, fabric, metal, or similar material to provide resiliency to allow the diaphragm 106 to oscillate and return to a position.

Any number of magnets 204 may be provided around the perimeter of the acoustic transducer device 200. In this example, four magnets 204 are provided, one positioned at each side of the generally rectangular device 200, to surround a central magnet 102.

FIG. 3, the acoustic transducer device 200 may include a central magnet 102. The back plate 208 and a pole plate 104 may sandwich the central magnet 102. That is, the back plate 208 may be positioned on a side of the magnet 102 opposite the location of the pole plate 104.

The acoustic transducer device 200 may further include a top plate 300. The top plate 300 and the pole plate 104 may be positioned to bracket a gap 110 that accommodates a coil 108 connected to the diaphragm 106 and/or suspension 206. Ends of the pole plate 104 and the top plate 300 may face each other from opposite sides of the gap 110. The top plate 300 and the back plate 208 may sandwich the perimeter magnets 204.

The perimeter magnet 204 and the central magnet 102 may be positioned to bracket the gap 110. Ends of the magnets 102, 204 may face each other from opposite sides of the gap 110.

The pole plate 104, back plate 208, and top plate 300 may be to direct magnetic flux of the magnets 102, 204 into the gap 110. Each of the pole plate 104, back plate 208, and top plate 300 may include a nickel alloy having nickel as a principal component. The pole plate 104, back plate 208, and top plate 300 may be made of the same material.

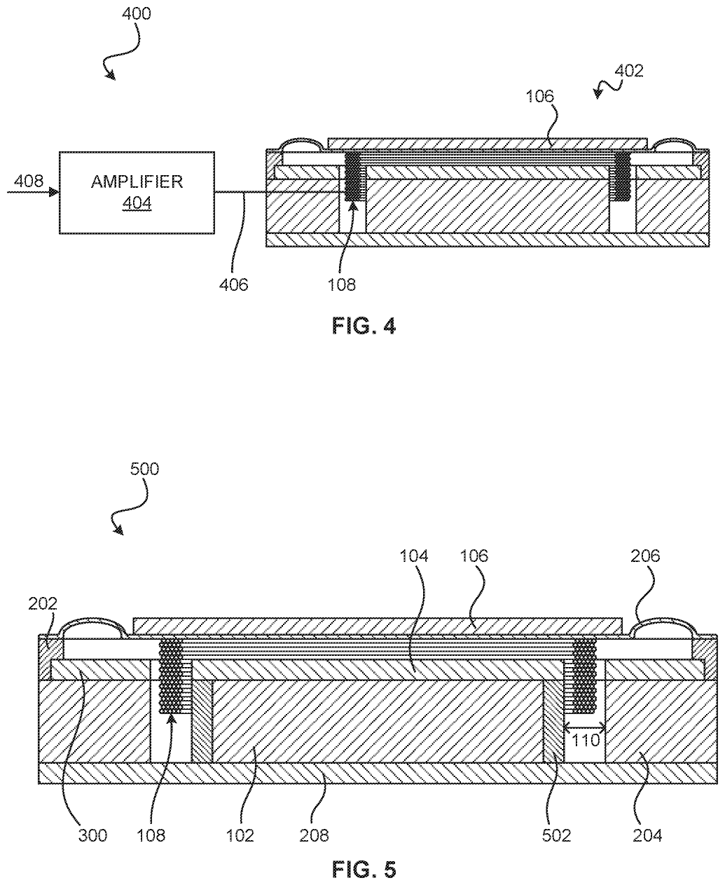

FIG. 4 shows an example speaker device 400. The speaker device 400 includes an example acoustic transducer device 402 and an amplifier 404. The acoustic transducer device 402 may be any of the acoustic transducer devices discussed herein. Uke reference numerals denote like components.

The amplifier 404 is connected to a coil 108 of the acoustic transducer device 402 by a conductor 406, such as a wire. The amplifier 404 is to provide an electrical audio signal to the coil 108 to output the signal as sound by oscillation of a diaphragm 106 of the acoustic transducer device 402. The amplifier 404 may be a class D amplifier, in which an amplifying transistor may operate as a switch, as opposed to a linear gain device. The amplifying transistor may be switched by a modulator using a pulse-width or pulse-density technique to encode an audio input signal into a series of pulses. The amplifier 404 may be provided with an input signal 408 to be outputted as audio via the acoustic transducer device 402.

FIG. 5 shows another example acoustic transducer device 500. The acoustic transducer device 500 may be a speaker, microphone, or similar. The acoustic transducer device 500 may be similar to the other acoustic transducer devices discussed herein and related description may be referenced. Uke reference numerals denote like components.

The acoustic transducer device 500 may include a short ring 502 between a central magnet 102 and a gap 110 that accommodates a coil 108. The short ring 502 may surround the central magnet 102. The short ring 502 may be composed of a material that includes copper, such as elemental copper or copper alloy. The short ring 502 may increase symmetry of the magnetic field in the gap 110.

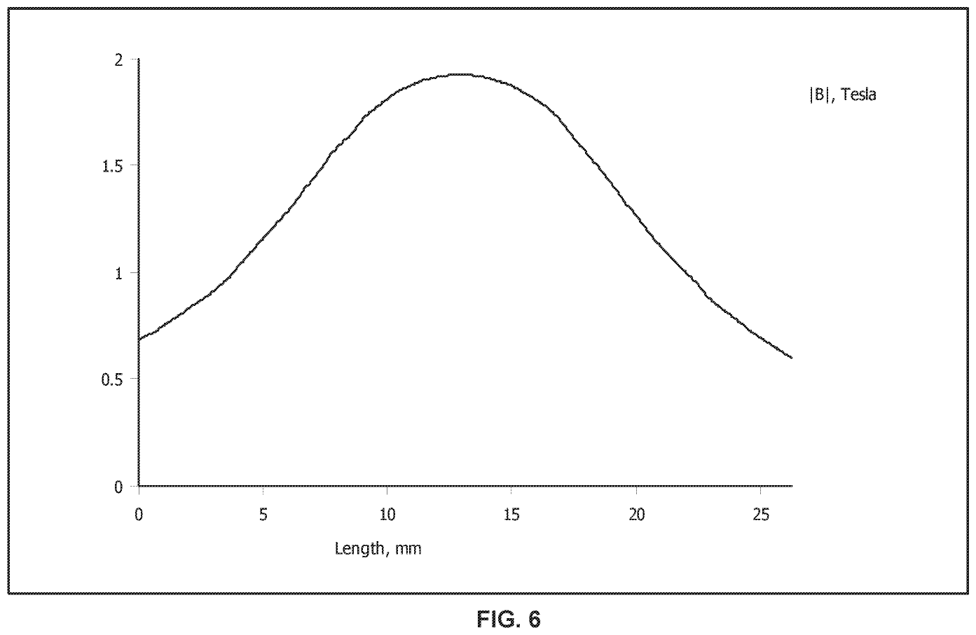

FIG. 6 shows a gap-sweep graph of simulated magnetic flux density for an example acoustic transducer device. A simulation was performed for a modeled acoustic transducer device similar to that shown in FIGS. 2 and 3. Magnetic flux density, B, was computed at locations within a gap 110 along a direction of travel of a coil 108, the direction of travel being about parallel to arrow 114 shown in FIG. 1.

A high nickel alloy pole plate allows a relatively strong magnet to be used in an acoustic transducer device. A strong magnet may be used to saturate the pole plate. This may result in lower power consumption for the same sound output. Micro-speakers, which may be 20 mm or smaller, using such a pole plate may be used in applications, such as wearable devices, that require efficient power usage and low mass. In addition, mass may further be reduced by a coil that includes beryllium.

It should be recognized that features and aspects of the various examples provided above can be combined into further examples that also fall within the scope of the present disclosure. In addition, the figures are not to scale and may have size and shape exaggerated for illustrative purposes.

1. An acoustic transducer device comprising:
a magnet;
a pole plate connected to the magnet, the pole plate including a nickel-iron alloy having nickel as a principal component;
a diaphragm movable relative to the pole plate to generate a sound; and
a coil connected to the diaphragm and to extend into a gap at the pole plate, the coil to magnetically interact with a magnetic field provided to the gap by the magnet and the pole plate to drive the diaphragm.

2. The device of claim 1, wherein the pole plate includes a nickel-iron alloy having at least 70% nickel.

3. The device of claim 2, wherein the magnet has a residual flux density of at least 1.4 tesla.

4. The device of claim 2, wherein the magnet has a maximum energy product of at least 370 kilojoules per cubic meter.

5. The device of claim 1, wherein the pole plate includes supermalloy.

6. The device of claim 5, wherein the magnet is a neodymium magnet of grade N50 or N52.

7. The device of claim 1, wherein the coil is composed of beryllium.

8. The device of claim 1, wherein the coil is composed of beryllium-copper alloy.

9. The device of claim 1, further comprising a short ring positioned between the magnet and the gap.

10. The device of claim 1, further comprising a back plate and a top plate, the back plate and the pole plate to sandwich the magnet, the top plate and the pole plate to bracket the gap, the back plate and the top plate including a nickel-iron alloy having nickel as a principal component.

11. An acoustic transducer device comprising:
a magnet;
a pole plate connected to the magnet, the pole plate including a nickel alloy;
a diaphragm movable relative to the pole plate to generate a sound; and
a coil connected to the diaphragm and to extend into a gap at the pole plate, the coil to magnetically interact with a magnetic field provided to the gap by the magnet and the pole plate to drive the diaphragm, wherein the coil includes beryllium.

12. The device of claim 11, wherein the coil is principally composed of beryllium.

13. The device of claim 12, wherein the pole plate includes a nickel-iron alloy having at least 70% nickel and wherein the magnet has a residual flux density of at least 1.4 tesla and has a maximum energy product of at least 370 kilojoules per cubic meter.

14. A speaker device comprising:
a magnet;
a pole plate connected to the magnet, the pole plate including a nickel-iron alloy;
a diaphragm movable relative to the pole plate to generate a sound;
a coil connected to the diaphragm and to extend into a gap at the pole plate, the coil to magnetically interact with a magnetic field provided to the gap by the magnet and the pole plate to drive the diaphragm; and
an amplifier connected to the coil to provide an electrical audio signal to the coil to output as the sound by the diaphragm.

15. The device of claim 14 wherein the amplifier is a class D amplifier.
